(19) United States
(12) Patent Application Publication
(10) Pub. No.: US 2012/0213370 A1
(43) Pub. Date: Aug. 23, 2012

(54) SECURE MANAGEMENT AND PERSONALIZATION OF UNIQUE CODE SIGNING KEYS

(75) Inventors: Stuart P. Moskovics, San Diego, CA (US); Xin Qiu, San Diego, CA (US); Joel D. Voss, Elkhorn, WI (US); Alexander Medvinsky, San Diego, CA (US)

(73) Assignee: GENERAL INSTRUMENT CORPORATION, Horsham, PA (US)

(21) Appl. No.: 13/150,636

(22) Filed: Jun. 1, 2011

Related U.S. Application Data
(60) Provisional application No. 61/444,167, filed on Feb. 18, 2011.

(51) Int. Cl. H04L 9/08

(52) U.S. Cl. 380/278

(57) ABSTRACT

A method and system generates and distributes unique cryptographic device keys. The method includes generating at least a first device key and encrypting the first device key with a first encrypting key to produce a first encrypted copy of the device key. The method also includes encrypting the first device key with a second encrypting key to produce a second encrypted copy of the device key. The second encrypting key is different from said first encrypting key. The first and second encrypted copies of the device keys are associated with a device ID identifying a computing device being manufactured. The second encrypted copy of the device key is loaded onto the computing device. The first encrypted copy of the device key and the device ID with which it is associated are stored onto at least one server for subsequent use after the computing device has been deployed to a customer.

### RELATED APPLICATIONS

This application claims priority from U.S. provisional application No. 61/444,167, filed Feb. 18, 2011, which is incorporated by reference herein in its entirety.

### BACKGROUND

In computing devices a variety of mechanisms and systems are implemented to protect against malware and software that has been modified without authorization. One of the most common methods is to provide a digital signature of the code or data which is checked before the code or data are executed or accessed. Methods for digitally signing code and data are widely used with software written for a variety of different computing devices such as mobile communication devices (e.g., personal digital assistants (PDAs), mobile phones, laptops, pagers, wireless email devices), PCs, routers, media players, set-top boxes and the like. For example, code signing is often used with mobile communication devices, such as cellular telephones, due to the need to protect the assets owned by the manufacturer, protection of operator business models, and protection against certain malware threats.

Code or data that is integrity protected by a digital signature is “signed” by a certifying authority before it is sold or otherwise distributed. Signed code or data includes a digital signature which confirms the code or data has not been tampered with since it was signed. FIG. 1 is a diagram illustrating an example code signing protocol in which a code signing authority provides code signing services to a software application developer is shown generally as 100.

A software application developer 102 creates a software application 104 for computing device 100. It will be understood that software applications comprise software code that may ultimately be executed on a mobile device or other computing device. Consequently, the terms “code signing” and “application signing” may be used interchangeably herein.

To protect against unauthorized access to sensitive data on the computing device, software application developer 102 is required to obtain one or more digital signatures from the mobile device manufacturer or from a code signing authority 106 acting on behalf of the manufacturer, and distribute the signature(s) for software application 104 as described in further detail below. In some cases, the signature may be appended to the signed data or code. In other cases, the signature is distributed in a separate file or package.

In the example shown in FIG. 1, when software application developer 102 requires software application 104 to be signed, software application 104 is sent from application developer 102 to code signing authority 106. Code signing authority 106 may represent the computing device manufacturer or possibly others that are able to approve software running on a device. While not explicitly shown in FIG. 1, in certain situations, it will be understood that a software application may be submitted to more than one code signing authority.

The digital signature is typically a cryptographic value that is generated using a private signature key 110 maintained solely by code signing authority 106. For example, according to one signature scheme, a hash of software application 104 may be generated by code signing authority 106, using a hashing algorithm such as the Secure Hash Algorithm SHA1 for example, and then encoded with private signature key 310 to create the digital signature. While private signature key 110 is used to encode a hash of information to be signed in this example, such as may be derived from software application 104, private signature key 110 may be used in other ways to generate a digital signature from the information to be signed or a transformed version of the information. In lieu of, or in addition to the digital signature, in some cases an additional symmetric or public code encryption key may be used to encrypt the software application 104. Note that a public key would typically be used to indirectly encrypt a random symmetric key which then in turn encrypts the software application 104.

Signed software application 108 may then be sent to computing device 100 over a network 200 for example, or otherwise loaded onto computing device 100. In order to execute signed and/or encrypted application 108 on the computing device 100, computing device 100 needs to verify the digital signature of the signed and/or encrypted application 108 using a public verification key 112.

Security protocols involving software code signing schemes typically rely on public and private encryption keys. In accordance with known public key cryptographic techniques, data encrypted using a private key of a private key/public key pair can only be decrypted using the corresponding public key of the pair, and vice-versa. Code signing that is performed in this manner may be referred to as asymmetric code signing.

Since in asymmetric code signing it is the public portion of the public/private key pair that is stored on the computing device 100, the same public verification key may be used on all units of a particular device model. Each unit of a given device model is thus provided with the same public code verification key (which corresponds to the signing key) at the time of manufacturer, thereby simplifying the manufacturing process and key management process.

However, in some cases, a computing device manufacturer may wish to use a unique symmetric signing key for each manufactured device. A symmetric key may be required due performance criteria and hardware limitations in the device. And in the case of symmetric code signing keys, it is preferred to have a unique key per device. That way, if a single device is broken and the symmetric signing/verification key is extracted, the compromise does not affect the security of other devices.

In addition, a device may require a unique asymmetric key pair for uses other than code verification—e.g., for decryption of code that was uniquely encrypted just for that device.

For the purpose of code encryption, it may be advantageous to utilize an asymmetric key pair where both encrypt and decrypt key are considered to be a secret value. Keeping the encrypt key secret prevents unauthorized parties from encrypting and delivering code images to each device. And the decrypt key is kept secret so that the code remains confidential outside of a target device. It is common to call the encrypt key public and the decrypt key private, although within this document a public encryption key is considered to be a secret confidential value that requires protection from unauthorized parties.

Advantageously, when both the code encryption and decryption keys (from an asymmetric key pair) are kept secret, it is not necessary for the code to be digitally signed. Since encryption keys are known only to authorized parties—if a device is able to successfully decrypt code, that is already sufficient proof that the code came from an authorized source.

### SUMMARY

In accordance with the present invention, a method and system is provided for generating and distributing unique cryptographic device keys. The method includes generating at least a first device key and encrypting the first device key with a first encrypting key to produce a first encrypted copy of the device key. The method also includes encrypting the first device key with a second encrypting key to produce a second encrypted copy of the device key. The second encrypting key is different from said first encrypting key. The first and second encrypted copies of the device keys are associated with a device ID identifying a computing device being manufactured. The second encrypted copy of the device key is loaded onto the computing device. The first encrypted copy of the device key and the device ID with which it is associated are stored onto at least one server for subsequent use after the computing device has been deployed to a customer.

In accordance with another aspect of the invention, a system is provided which provides code signing services. The system includes a key store for storing a plurality of encrypted device key pairs that each include a first and second encrypted copy of a device key. Each of the first encrypted copies of the device keys encrypt a first device key with a first encrypting key and each of the second encrypted copies of the device keys encrypt the first device key with a second encrypting key such that the second encrypted copy of the device key is different from the first encrypted copy of the device key. The system also includes one or more servers in communication with the key store. The one or more servers are configured to (i) link each of the encrypted device key pairs to a respective device ID of a respective computing device to be provisioned with signed and/or encrypted software code; (ii) deliver to a code signing server the first encrypted copy of the device key in a first device key pair linked to a first of the device IDs; (iii) deliver to the computing device identified by the first device ID the second encrypted copy of the device key and (iv) decrypt the first device key from the first encrypted copy of the device key in the first device key pair and encrypt the software code with the first device key and (v) deliver the signed and/or encrypted software code to the computing device identified by the first device ID.

In accordance with yet another aspect of the invention, a method is provided for delivering code signing services using unique cryptographic device keys. The method includes receiving a first encrypted copy of a device key that encrypts a first device key with a first encrypting key. A second encrypted copy of the device key is also received. The second encrypted copy encrypts the first device key with a second encrypting key such that the second encrypted copy of the device key is different from the first encrypted copy of the device key. The first and second encrypted copies of the device keys are linked with a device ID of a computing device to be provisioned with signed and/or encrypted software code. The first encrypted copy of the device key linked to the device ID is delivered to a first code signing server that provides the signed and/or encrypted software code that is to be provisioned in the computing device. The signed and/or encrypted software code is signed with the first device key. The second encrypted copy of the device key and the signed and/or encrypted software code is delivered to the computing device.

### BRIEF DESCRIPTION OF THE DRAWINGS

FIG. 1 is a diagram illustrating an example code signing protocol in which a code signing authority provides code signing services to a software application developer.

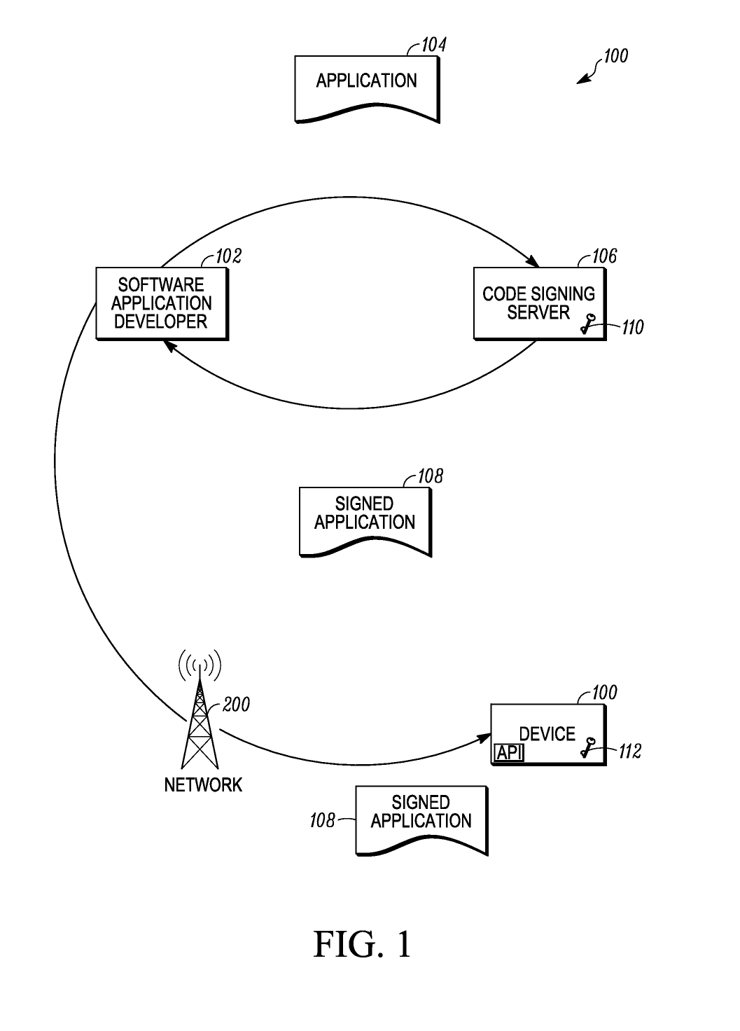

FIG. 2 shows the relationship between the unique device key and its two encrypted copies.

FIG. 3 shows one example of an operating environment in which the processes described herein for provisioning computing devices with unique signing keys may be implemented.

FIG. 4 shows another example of an operating environment in which the processes described herein for provisioning computing devices with unique signing keys may be implemented.

FIG. 5 is a flowchart illustrating one example of a method for providing code signing services using the techniques described herein.

FIG. 6 shows a computer system which may be used as a hardware platform for the any of the various servers, stations and the like of the systems shown in FIGS. 3 and 4.

### DETAILED DESCRIPTION

For a variety of reasons it may sometimes be desirable to apply a code signing mechanism that employs symmetric unique code signing keys rather than shared code signing keys. In one case, a product utilizing a low cost part may only support the use of symmetric keys instead of the generally used asymmetric keys. Unique device private keys may also be desirable for reasons other than code signing. For example, a unique device private key may be used to decrypt code or data uniquely encrypted for that device, where the corresponding public key also needs to be kept secret. The provisioning of a unique device key into each unit of a computing device presents a number of issues that need to be addressed concerning the generation and management of the unique keys. For instance, a device with a unique signing key which has been deployed and given to a customer may at some future time need to be repaired or updated. The repair or update center will often need access to the unique signing or encryption key to perform the repair or update. Accordingly, a system is needed to securely distribute, manage and retrieve the unique signing keys throughout their lifecycle.

A system for providing code signing services is described below which can be used to securely distribute, manage and retrieve the unique signing or encryption keys throughout their lifecycle. For illustrative purposes the system will be described in the context of the following scenarios: key provisioning in the factory at the time of device manufacture, use of unique signing or encryption keys during engineering development and the use of unique signing or encryption keys by a repair facility. Of course, the system may be used to distribute the unique device keys for other purposes as well. The devices on which the signed or encrypted code is to be provisioned may be any computing device, including, without limitation, a communication device, a mobile communication device (e.g., personal digital assistant (PDA), mobile phone, laptops, pager, wireless email device), PC, router, media player, set-top boxes and the like.

When provisioning a computing device with a unique device key, protection of the key at all times is paramount. It is important for the key to be encrypted whenever it is not in use to prevent unauthorized disclosure of the key value. Computing devices are typically manufactured at remote, untrusted third party facilities and the sensitive data is transferred over a computing network. Sensitive values such as unique device keys need to be protected starting from their birth at the device manufacturer until they are stored in the destination computing device. With code signing or code encryption keys, the keys will need to be used after manufacture to sign and/or encrypt code updates. It is substantially more difficult to protect unique code signing and encryption keys after manufacture due to the possible large number of unique keys to be stored.

To implement this system two encrypted versions are created of each unique device key that is provisioned in a computing device. One encrypted version is used by the manufacturer for distribution to the target device and the other version is made available to entities that may need to access the unique device key at some later time, such as after the computing device has been deployed and needs to be repaired or updated or when it needs to be analyzed for engineering development purposes. The device manufacturer may be one of the entities using the second encrypted version.

The computing device is provisioned with an asymmetric key value called the DKPK (Device Key Protection Key) at the time of manufacture, before loading the unique device keys. The DKPK is shared among all devices of a model. The DKPK is used to protect the unique signing key starting from birth at the device manufacturer until it is securely stored in the target computing device. While the DKPK is described as an asymmetric key, it could also be a symmetric key. Also, the DKPK could be a shared value among all devices of a specific model or it could be a unique value as well.

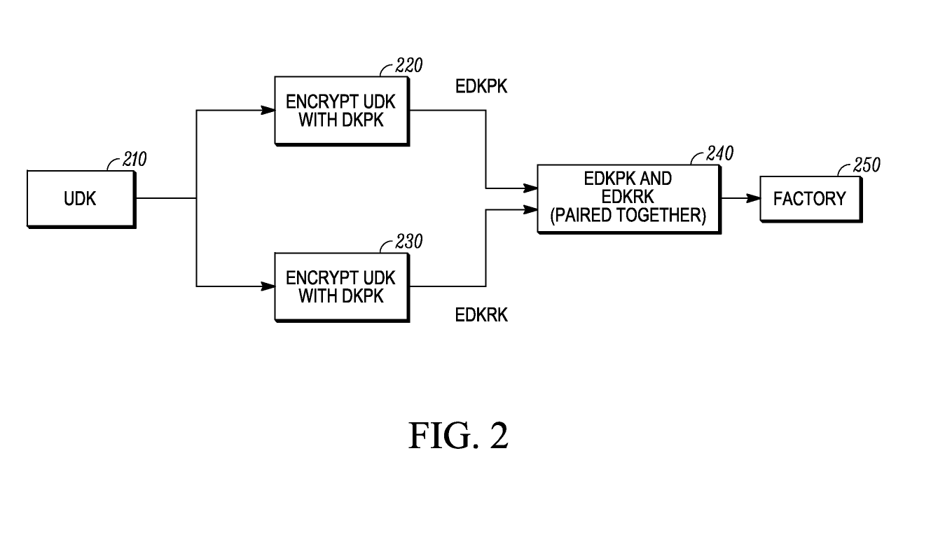

The relationship between the unique device key and its two encrypted versions or copies is illustrated in FIG. 2. In this example the unique device key, shown at block 210, which is provisioned in each computing device is referred to as the Unique Device Key (UDK). As shown at block 220, the UDK is encrypted with the DKPK. The DKPK is used to protect the UDK from the time it is first generated by the key generation system until it is provisioned in a computing device in the factory 250. The computing device decrypts the UDK using the DKPK, which is pre-provisioned and stored in the computing device. The encrypted key formed by encrypting the UDK with the DKPK is referred to as the Encrypted Device Key for Device Key Protection Key (EDKPK). The EDKPK is the encrypted version of the UDK that will be provisioned in the computing device in the factory. The EDKPK is the value that is transferred from the device manufacturer to the manufacturing center.

As shown at block 230, the UDK is also separately encrypted with an asymmetric key that is referred to as the Device Key Retrieval Key (DKRK). While the DKRK is described as an asymmetric key, it could also be a symmetric key. The encrypted key formed by encrypting the UDK with the public portion of the DKRK is referred to as the Encrypted Device Key by the Retrieval Key (EDKRK). The DKRK is the encrypted version of the UDK that will be provided to the various entities that will sign code, both for use within the factory and outside the factory (e.g., repair facilities). The private portion of the DKRK will be stored in the various code signing servers so that they can decrypt the UDK to perform code signing or encryption. The EDKRK is the value that is transferred from the device manufacturer to the signing entities.

In summary, FIG. 2 depicts the formation of two encrypted versions of the UDK: the EDKPK and the EDKRK. The EDKPK and EDKRK are paired together (block 240) for delivery to factory 250. The EDKPK and EDKRK are transferred together from the device manufacturer to the factory because they are not tied to a device until manufacture. The EDKRK is not useful for code signing unless it is known which device was loaded with the UDK associated with the EDKRK. The factory records the serial number (or other unique value) from the manufactured device and pairs it with the EDKRK for later retrieval. Therefore, any entity that needs to sign code for the device will be able to retrieve the correct EDKRK (and UDK, after decryption) by searching for the EDKRK associated with the serial number.

It should be noted that in the examples presented herein the device key UDK is a symmetric key. More generally, however, the device key may be either a symmetric or asymmetric key. If the device key is asymmetric, then its public portion (generally used for encryption) will be referred to as the Unique Device Public Key (UDPK). Despite its name, the UDPK may need to be kept secret (in addition to keeping the private key secret). This enables authorization control as to which entities are permitted to encrypt code or other information targeted to a specific device. Of course, if the device key is symmetric, then the UDK effectively serves as the UDPK.

Two examples of a mechanism for securely distributing, managing and retrieving the unique signing keys will be presented below. In the first example, the UDKs are generated and encrypted offline by a key generation facility and delivered to the factory so that they can be provisioned in the computing devices. In the second example, the UDKs are generated and encrypted within the factory that provisions them in the computing devices. In neither case is a UDK made available in the clear until it is provisioned in a computing device or until it is used by a code signing server.

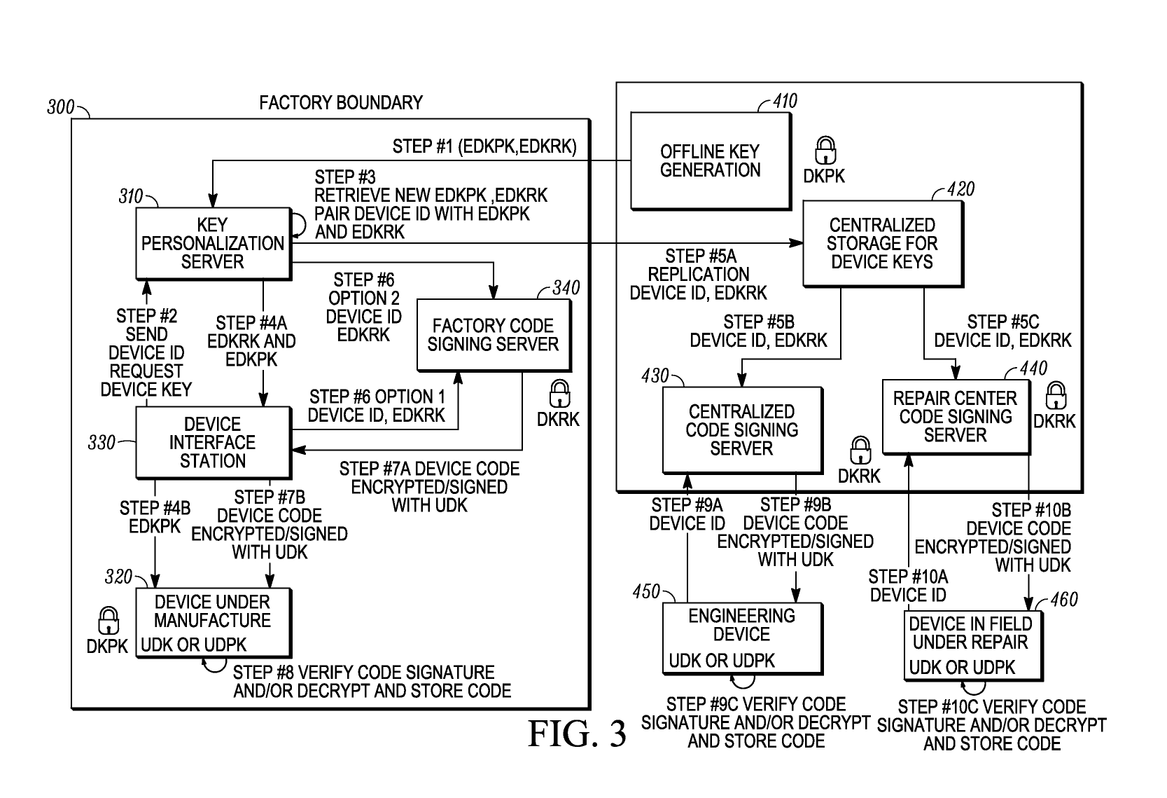

FIG. 3 shows one example of an operating environment in which the processes described herein for provisioning computing devices with unique signing keys may be implemented. For purposes of illustration the device key is assumed to be symmetric. However, as previously mentioned, the device key alternatively may be asymmetric, in which case, as the figure illustrates, the EDKPK includes only an encrypted private portion of the device key that is delivered to the computing device. On the other hand, the EDKRK includes only an encrypted public portion of the device key (UDPK). The device requires the private key to decrypt code or other information which is delivered encrypted with UDPK, e.g., by a code signing server. It is understood that a code signing server may perform signing of code or other messages targeted to a device, as well as encryption of code or other digital information targeted to a device.

A factory domain 300 is shown in FIG. 3, which is representative of a manufacturing facility for the computing devices in which the device keys are to be provisioned. It should be understood that this domain is shown in a highly simplified manner in which a single entity (e.g., server, station, etc) may be representative of more complex arrangements and systems.

Also shown in FIG. 3 are other entities which may be operated by third parties or in some cases by the manufacturer themselves. In particular, offline key generation system 410 is shown, which may include, or have access to, hardware security modules (HSMs) which may be used to protect some or all of the keys. Also shown are signing servers 430 and 440, which may be used to sign or encrypt code or other digital information for use in the deployed computing devices (e.g., computing devices 450 and 460) for engineering and repair purposes, respectively.

The process flow through the various components shown in FIG. 3 is as follows. First, at step 1, the offline key generation system 410 generates a series of UDK. Each UDK is encrypted as described above to produce EDKPK and EKKRK pairs, which are delivered to a key personalization server 310 within factory domain 300. In this way the keys are never held in the clear after leaving the offline key generation system 410 until they are stored and decrypted in their respective destination computing devices (e.g. computing device 320).

Factory domain 300 includes a device interface station 330, which serves as a physical conduit between the destination computing device 320 that is under manufacture and the key personalization server 310. The computing device 320 may be physically connected to the device interface stations by any suitable means such as, for example, a USB cable if a USB port is available on the computing device 320. The device interface station 330 retrieves the unique device ID from the computing device 320 and in step 2 sends it to the key personalization server 310, along with a request for a device key.

In step 3 the key personalization server 310 receives the request from the device interface station 330 and retrieves the next available encrypted EDKPK and EDKRK pair from its database. The server 330 then removes any server-specific protection layers that may have been used when the encrypted key pairs were sent from the offline key generation system 410 to the key personalization server 310. The EDKPK is to be loaded into the computing device 320 and the EDKRK is intended for secure storage by entities external to the factory for code signing/encryption purposes. The EDKRK may also be used during the device personalization process within the factory to sign/encrypt the initial software code that is loaded onto the computing device 320 by the device interface station 330. In another instance, the computing device 320 may sign/encrypt the initial software code with itself.

In step 4a the EDKPK and EDKRK pair is sent to the device interface station 330. The pair may be encrypted using an encrypted protocol to protect it during transit. The device interface station 330, in step 4b, removes any additional encryption that may have protected the pair during transit and sends the EDKPK to the computing device 320 under manufacture. The computing device 320 decrypts the EDKPK with the DKPK to retrieve the UDK (in the case of asymmetric keys it would be just the private portion of UDK). In some cases, the device may sign the initial code loaded during the factory itself using its own symmetric UDK.

The key personalization server 420 needs to store the EDKRK and its linkage to a device ID for later use subsequent to the device personalization process. Accordingly, in step 5a the key personalization server 310 stores the device ID and EDKRK pair, then replicates these values to a centralized storage 420. As previously noted, code updates for the device need to be signed and/or encrypted with each device's UDK during engineering development and during device repair at a repair facility. Accordingly, in step 5b the centralized storage 420 sends the EDKRK and device ID pair to a central code signing server 430 where it can be used for engineering purposes in connection with engineering computing device 450. In addition, the centralized storage 420 also sends the EDKRK and device ID pair to repair center 440 in step 5c, where it can be used when a customer brings in a computing device 460 for a repair or upgrade. Of course, in other examples the EDKRK and device ID pair may be made available to other signing servers or entities as appropriate under the particular circumstances.

As FIG. 3 indicates, the code signing server 430 and repair center 440 have been previously provisioned with the DKRK, which is stored in a hardware security module or other secure storage, which is used to decrypt the EDKRK to obtain the UDK. The code signing server 430 and repair center 440 can then use the UDK to sign/encrypt any trusted software code that is to be loaded onto a computing device. In the case of asymmetric device keys, the code signing server 440 decrypts EDKRK to obtain just the public portion of UDK (UDPK) which is used for encryption of code or other digital information which is to be delivered to a specific device.

The repair center 440 will generally have its own code signing server. This code signing server can retrieve the appropriate EDKRK based upon a request for a specific device ID. The code signing server will then decrypt the EDKRK using the DKRK preferably stored securely in a Hardware Security Module or other similar mechanism. Software code provided by a trusted third party can then be signed/encrypted using the UDK and the signed/encrypted code can in turn be loaded onto the computing device being repaired or updated.

Returning to the factory domain 330, the computing device 320, which has previously been provisioned with the EDKPK in step 4b, undergoes the remainder of the device personalization process. The next part of the process involves loading signed code onto the computing device using the factory code signing server 340, which contains the necessary software code to be loaded onto the computing device 320. This process requires the code to be signed and/or encrypted using the UDK uniquely assigned to the computing device 320. To perform this process, the factory code signing server 340 needs to receive the corresponding EDKRK and device ID pair. In the example shown in FIG. 3 this can be accomplished in one of two ways. First, in step 6, option 1, the EDKRK and device ID pair can be sent to the factory code signing server 340 by the device interface station 330. Alternatively, in step 6, option 2, the EDKRK and device ID pair can be sent to the factory code signing server 340 by the key personalization server 310. The factory code signing server 340 decrypts the EDKRK using the DKRK, with which it has been pre-provisioned, to obtain the UDK. The factory code signing server 340 uses the UDK to sign and/or encrypt the software code.

In step 7a the factory code signing server 340 sends the required software code to the device interface station 330. The software code has been signed and/or encrypted with the UDK for the particular computing device 320. The device interface station 330, in turn, loads the signed and/or encrypted software code onto the computing device 320 in step 7b. The computing device 320, which has previously received and decrypted the EDKPK in step 4b to obtain the UDK, verifies and decrypts the software code in step 8 using the UDK, loads it into volatile memory and then executes this code. Alternatively, the computing device stores the clear software code in non-volatile memory and loads and executes it at a later time.

Step 9 illustrates the situation where an engineering computing device 450 needs to be provisioned with updated code at an engineering facility. To accomplish this, a trusted employee in step 9a accesses a trusted server and transmits the device ID from the engineering computing device 450 to the central code signing server 430. The signing server 430 retrieves the EDKRK linked to that device ID and decrypts the EDKRK using the DKRK preferably stored in its Hardware Security Module. The central code signing server 430 signs and/or encrypts the code using the UDK and returns the signed and/or encrypted code to the trusted employee in step 9b, who loads the signed/encrypted code onto the engineering computing device 450.

Similar to step 9, step 10 illustrates the situation where a previously deployed computing device 460 needs to be repaired at the repair center 440. To accomplish this, a trusted server accessible to the repair center 440 accesses the device ID from the computing device 460. The trusted server retrieves the EDKRK linked to that device ID and decrypts the EDKRK using the DKRK preferably stored in its Hardware Security Module. The trusted server signs and/or encrypts the code needed to perform the repair using the UDK and loads the signed and/or encrypted code onto the computing device 460 needing repair or updating.

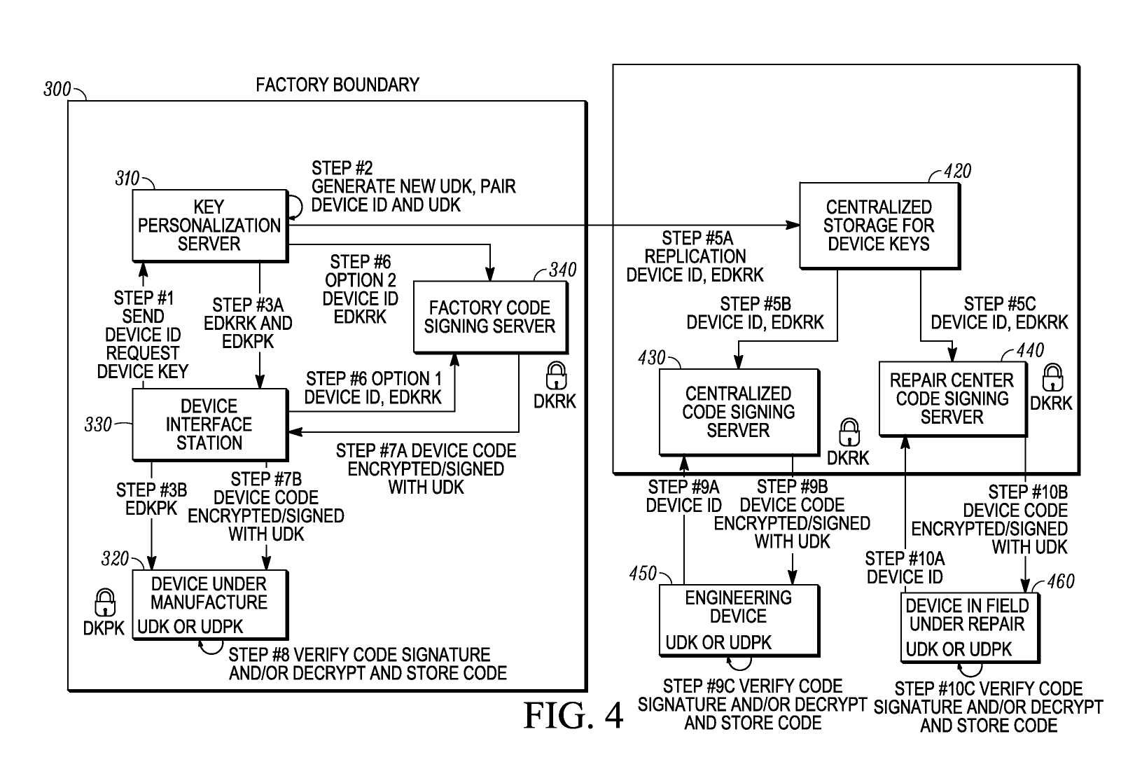

FIG. 4 shows another example of an operating environment in which the processes described herein for provisioning computing devices with unique device keys may be implemented. In FIGS. 3 and 4 like elements are denoted by like reference numerals. Whereas in the example of FIG. 3 the UDKs are generated and encrypted offline, in the example of FIG. 4 the UDKs are generated and encrypted by the key personalization server 310 at the time of device personalization. In this example the process begins at step 1 when the key personalization server receives the unique device ID from the device interface station 330 along with a request to assign a EDKPK/EDKRK pair to the device ID. In step 3 the key personalization server 310 generates a new UDK for the computing device and then encrypts the UDK with the DKPK to create the EDKPK. Likewise, the key personalization server 310 also encrypts the UDK with the DKRK to obtain the EDKRK. The key personalization server 310 then removes any local copies of the UDK and only stores the pairing of the ID with the EDKPK and the EDKRK.

The remainder of the process flow through the system of FIG. 4 proceeds as in FIG. 3. That is, step 3 in FIG. 4 corresponds to step 4 in FIG. 3, step 4 in FIG. 4 corresponds to step 5 in FIG. 3, and so on.

More specifically, in step 3a of FIG. 4 the EDKPK and EDKRK pair is sent to the device interface station 330. The pair may be encrypted using an encrypted protocol to protect it during transit. The device interface station 330, in step 3b, removes any additional encryption that may have protected the pair during transit and sends the EDKPK to the computing device 320 under manufacture. The computing device 320 decrypts the EDKPK with the DKPK to retrieve the UDK (in the case of asymmetric keys it would be just the private portion of UDK). In some cases, the device may sign the initial code loaded during the factory itself using its own symmetric UDK.

The key personalization server 420 needs to store the EDKRK and its linkage to a device ID for later use subsequent to the device personalization process. Accordingly, in step 4a the key personalization server 310 stores the device ID and EDKRK pair, then replicates these values to a centralized storage 420. As previously noted, code updates for the device need to be signed and/or encrypted with each device's UDK during engineering development and during device repair at a repair facility. Accordingly, in step 4b the centralized storage 420 sends the EDKRK and device ID pair to a central code signing server 430 where it can be used for engineering purposes in connection with engineering computing device 450. In addition, the centralized storage 420 also sends the EDKRK and device ID pair to repair center 440 in step 4c, where it can be used when a customer brings in a computing device 460 for a repair or upgrade. Of course, in other examples the EDKRK and device ID pair may be made available to other signing servers or entities as appropriate under the particular circumstances.

As FIG. 3 indicates, the code signing server 430 and repair center 440 have been previously provisioned with the DKRK, which is stored in a hardware security module or other secure storage, which is used to decrypt the EDKRK to obtain the UDK. The code signing server 430 and repair center 440 can then use the UDK to sign/encrypt any trusted software code that is to be loaded onto a computing device. In the case of asymmetric device keys, the code signing server 440 decrypts EDKRK to obtain just the public portion of UDK (UDPK) which is used for encryption of code or other digital information which is to be delivered to a specific device.

The repair center 440 will generally have its own code signing server. This code signing server can retrieve the appropriate EDKRK based upon a request for a specific device ID. The code signing server will then decrypt the EDKRK using the DKRK preferably stored securely in a Hardware Security Module or other similar mechanism. Software code provided by a trusted third party can then be signed/encrypted using the UDK and the signed/encrypted code can in turn be loaded onto the computing device being repaired or updated.

Returning to the factory domain 330, the computing device 320, which has previously been provisioned with the EDKPK in step 3b, undergoes the remainder of the device personalization process. The next part of the process involves loading signed code onto the computing device using the factory code signing server 340, which contains the necessary software code to be loaded onto the computing device 320. This process requires the code to be signed and/or encrypted using the UDK uniquely assigned to the computing device 320. To perform this process, the factory code signing server 340 needs to receive the corresponding EDKRK and device ID pair. In the example shown in FIG. 3 this can be accomplished in one of two ways. First, in step 5, option 1, the EDKRK and device ID pair can be sent to the factory code signing server 340 by the device interface station 330. Alternatively, in step 5, option 2, the EDKRK and device ID pair can be sent to the factory code signing server 340 by the key personalization server 310. The factory code signing server 340 decrypts the EDKRK using the DKRK, with which it has been pre-provisioned, to obtain the UDK. The factory code signing server 340 uses the UDK to sign and/or encrypt the software code.

In step 6a the factory code signing server 340 sends the required software code to the device interface station 330. The software code has been signed and/or encrypted with the UDK for the particular computing device 320. The device interface station 330, in turn, loads the signed and/or encrypted software code onto the computing device 320 in step 6b. The computing device 320, which has previously received and decrypted the EDKPK in step 3b to obtain the UDK, verifies and decrypts the software code in step 7 using the UDK, loads it into volatile memory and then executes this code. Alternatively, the computing device stores the clear software code in non-volatile memory and loads and executes it at a later time.

Step 8 illustrates the situation where an engineering computing device 450 needs to be provisioned with updated code at an engineering facility. To accomplish this, a trusted employee in step 9a accesses a trusted server and transmits the device ID from the engineering computing device 450 to the central code signing server 430. The signing server 430 retrieves the EDKRK linked to that device ID and decrypts the EDKRK using the DKRK preferably stored in its Hardware Security Module. The central code signing server 430 signs and/or encrypts the code using the UDK and returns the signed and/or encrypted code to the trusted employee in step 9b, who loads the signed/encrypted code onto the engineering computing device 450.

Similar to step 8, step 9 illustrates the situation where a previously deployed computing device 460 needs to be repaired at the repair center 440. To accomplish this, a trusted server accessible to the repair center 440 accesses the device ID from the computing device 460. The trusted server retrieves the EDKRK linked to that device ID and decrypts the EDKRK using the DKRK preferably stored in its Hardware Security Module. The trusted server signs and/or encrypts the code needed to perform the repair using the UDK and loads the signed and/or encrypted code onto the computing device 460 needing repair or updating.

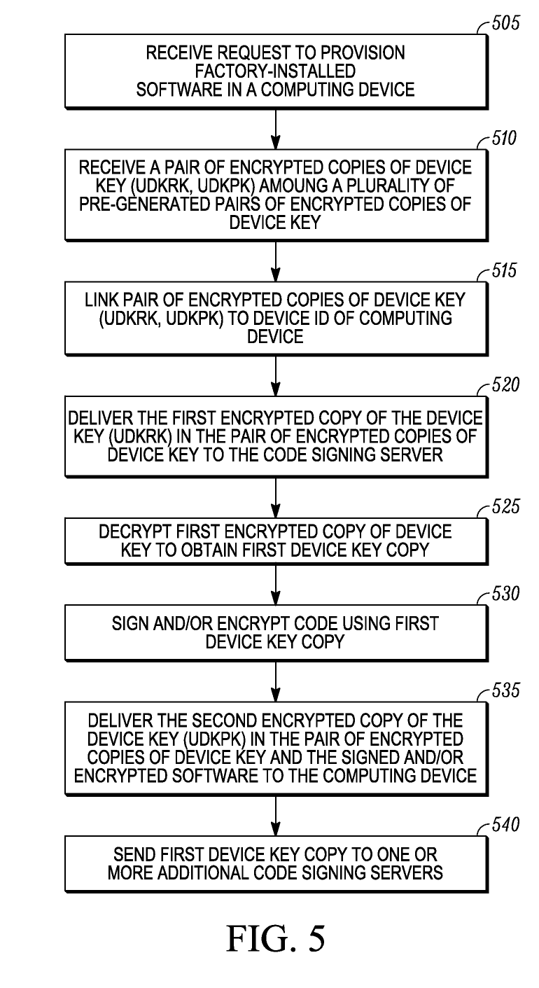

FIG. 5 is a flowchart illustrating one example of a method for generating and distributing unique cryptographic device keys using the techniques described herein. The cryptographic keys may be provided for a variety of purposes, including but not limited to code signing and/or encryption services. The method begins in step 505 when, in this particular example, a request is received to provision factory-installed software code in a computing device. The request includes the device ID of the computing device. If the particular system shown in FIG. 3 is employed, the request may be received by the key personalization server 310 from the device interface station 330. In response to the request, at step 510 a pair of encrypted copies (e.g., EDKPK/EDKRK) of a device key pair is retrieved from among a plurality of pre-generated pairs of encrypted device keys. In step 515, the retrieved pair of encrypted copies is linked with a device ID of a computing device to be provisioned with, e.g., signed and/or encrypted code. In step 520, a first encrypted copy of the retrieved pair is delivered to a server for subsequent use after the computing device has been deployed to a customer. In one implementation the server is a code signing server for provideing signed and/or encrypted software code that is to be provisioned in the computing device. The first encrypted copy of the retrieved pair is decrypted in step 525 by the server to obtain the first device key. In step 530, the server then signs and/or encrypts the software code using the first device key. The second encrypted copy of the retrieved pair of device keys and the signed and/or encrypted software code is delivered to the computing device in step 535. In addition, in step 540, the first encrypted copy of the retrieved pair of device keys linked to the device ID is sent to one or more additional servers so that the device key is available when, for instance, a computing device already delivered to a customer is brought to a repair center for a repair and/or an upgrade

One or more of the steps and functions described herein and one or more of the components of the systems described herein may be implemented as computer code comprising computer readable instructions stored on a computer readable storage device, such as memory or another type of storage device. The computer code is executed on a computer system, such as computer system 400 described below by a processor, such as an application-specific integrated circuit (ASIC), or other type of circuit. The code may exist as software programs comprised of program instructions in source code, object code, executable code or other formats.

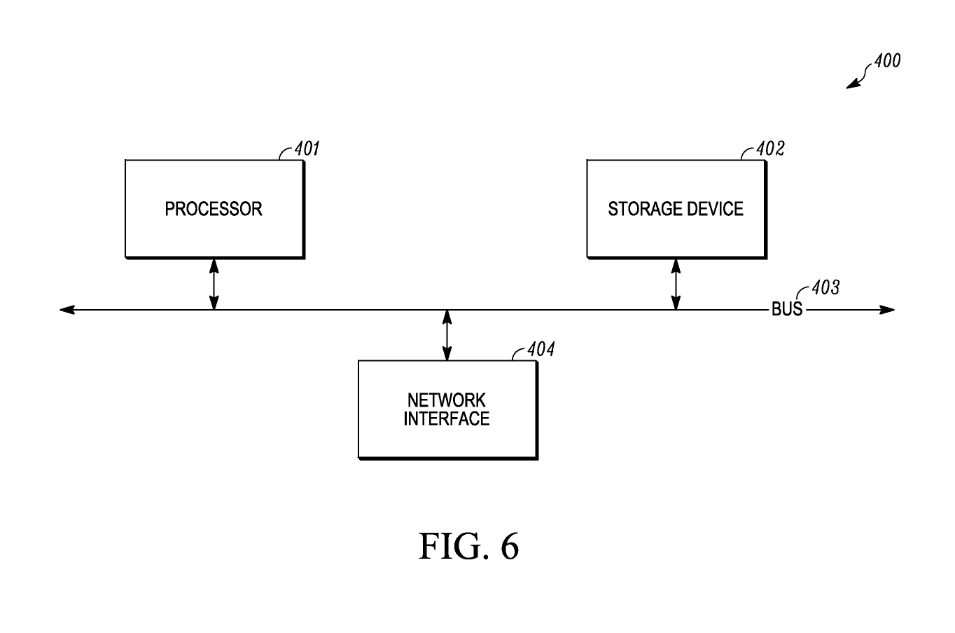

FIG. 6 shows a computer system 600 which may be used as a hardware platform for the any of the various servers, stations and the like of the systems shown in FIGS. 3 and 4. Computer system 600 may be used as a platform for executing one or more of the steps, methods, and functions described herein that may be embodied as software stored on one or more computer readable storage devices, which are hardware storage devices.

The computer system 600 includes a processor 601, or processing circuitry, that may implement or execute software instructions performing some or all of the methods, functions and other steps described herein. Commands and data from processor 601 are communicated over a communication bus 603. Computer system 600 also includes a computer readable storage device 602, such as random access memory (RAM), where the software and data for processor 601 may reside during runtime. Storage device 602 may also include non-volatile data storage. Computer system 600 may include a network interface 604 for connecting to a network. It is apparent to one of ordinary skill in the art that other known electronic components may be added or substituted in computer system 600.

As used in this application, the terms “component,” “module,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable storage media can include but are not limited to magnetic storage devices (e.g., hard disk, floppy disk, magnetic strips . . . ), optical disks (e.g., compact disk (CD), digital versatile disk (DVD) . . . , smart cards, and flash memory devices (e.g., card, stick, key drive . . . ). Of course, those skilled in the art will recognize many modifications may be made to this configuration without departing from the scope or spirit of the claimed subject matter.

1. A method for generating and distributing unique cryptographic device keys, comprising:
generating at least a first device key;
encrypting the first device key with a first encrypting key to produce a first encrypted copy of the device key;
encrypting the first device key with a second encrypting key to produce a second encrypted copy of the device key, said second encrypting key being different from said first encrypting key;
associating the first and second encrypted copies of the device keys with a device ID identifying a computing device being manufactured;
loading the second encrypted copy of the device key onto the computing device;
storing the first encrypted copy of the device key and the device ID with which it is associated onto at least one server for subsequent use after the computing device has been deployed to a customer.

2. The method of claim 1 wherein the first device key is generated and encrypted off-line and further comprising:
loading the first and second copies of the encrypted device keys without loading an unencrypted version of the first device key onto a key personalization server; and
using the key personalization server to associate the device ID with the first and second copies of the encrypted device keys.

3. The method of claim 1 wherein the first device key is a first signing key and further comprising signing and/or encrypting with the first signing key software code used for device personalization and loading the signed and/or encrypted software code onto the computing device being manufactured.

4. The method of claim 3 further comprising obtaining the first signing key used to sign/encrypt the software code by decrypting the first encrypted signing key.

5. The method of claim 1 wherein the first device key is a symmetric key.

6. The method of claim 1 wherein the first device key is a public portion of an asymmetric key pair.

7. The method of claim 5 wherein the first device key is unique to the computing device with which it is associated such that each of a plurality of computing devices are loaded with a second encrypted device key that encrypts a first device key that is different from an encrypted first device key loaded onto any other computing device.

8. At least one computer-readable medium encoded with instructions which, when executed by a processor, performs a method including:
receiving a first encrypted copy of a device key that encrypts a first device key with a first encrypting key;
receiving a second encrypted copy of the device key that encrypts the first device key with a second encrypting key such that the second encrypted copy of the device key is different from the first encrypted copy of the device key;
linking the first and second encrypted copies of the device keys with a device ID of a computing device to be provisioned with signed and/or encrypted software code.
delivering the first encrypted copy of the device key linked to the device ID to a first code signing server that provides the signed and/or encrypted software code that is to be provisioned in the computing device, wherein the signed and/or encrypted software code is signed with the first device key; and
delivering the second encrypted copy of the device key and the signed and/or encrypted software code to the computing device.

9. The computer-readable medium of claim 8 further comprising delivering the first encrypted device key linked to the device ID to one or more additional code signing servers.

10. The computer-readable medium of claim 8 wherein the first code signing server is a factory code signing server and the signed code provided by the first code signing server is factory-installed code and at least one of the additional code signing servers is associated with a facility that services computing devices after they have been deployed to customers.

11. The computer-readable medium of claim 8 further comprising receiving a request for software code, said request including the device ID of the computing device in which the code is to be provisioned and, in response thereto, generating and encrypting the first device key.

12. The computer-readable medium of claim 8 further comprising receiving a request for software code, said request including the device ID of the computing device in which the code is to be provisioned and, in response thereto, retrieving an encrypted device key pair from among a plurality of pre-generated encrypted device key pairs.

13. The computer-readable medium of claim 8 further comprising linking to different device IDs a different first and second encrypted device key pair encrypting a unique first device key.

14. A system for providing code signing services, comprising:
a key store for storing a plurality of encrypted device key pairs that each include a first and second encrypted copy of a device key, each of the first encrypted copies of the device keys encrypting a first device key with a first encrypting key and each of the second encrypted copies of the device keys encrypting the first device key with a second encrypting key such that the second encrypted copy of the device key is different from the first encrypted copy of the device key; and
one or more servers in communication with the key store, said one or more servers being configured to (i) link each of the encrypted device key pairs to a respective device ID of a respective computing device to be provisioned with signed and/or encrypted software code; (ii) deliver to a code signing server the first encrypted copy of the device key in a first device key pair linked to a first of the device IDs; (iii) deliver to the computing device identified by the first device ID the second encrypted copy of the device key and (iv) decrypt the first device key from the first encrypted copy of the device key in the first device key pair and encrypt the software code with the first device key and (v) deliver the signed and/or encrypted software code to the computing device identified by the first device ID.

15. The system of claim 14 wherein the one or more servers are further configured to deliver to one or more additional code signing servers the first encrypted device keys in the plurality of encrypted device key pairs linked to the respective ones of the device IDs.

16. The system of claim 14 further comprising a device interface station configured to establish communication with the computing device identified by the first device ID, send the first device ID of the computing device to the one or more servers and request from the one or more servers that an encrypted device key pair be linked to the computing device identified by the first ID.

17. The system of 14 wherein the one or more servers further comprise a key personalization server configured to receive the plurality of encrypted device key pairs from an offline key generation facility.

18. The system of claim 14 wherein the one or more servers comprises a factory code signing server configured to (i) receive the second encrypted device keys in the plurality of encrypted device key pairs and the device IDs respectively linked to the second encrypted device keys and (ii) cause the signed and/or encrypted software code linked to the first device ID of the computing device to be provisioned in the computing device.

19. The system of claim 17 further comprising a device interface station configured to (i) establish communication with the computing device and send the device ID of the computing device to the key personalization server; (ii) request from the key personalization server that an encrypted device key pair be linked to the device ID of the computing device; and (iii) send the second encrypted device key to the computing device.

20. The system of claim 19 wherein the factory code signing server is further configured to send the signed and/or encrypted software code to the device interface station.
